(19) United States
(12) Patent Application Publication
(10) Pub. No.: US 2026/0310607 A1
(43) Pub. Date: Oct. 8, 2026

(54) DYNAMIC ALLOCATION OF A LAST LEVEL CACHE (LLC) TO A FEATURE IN A HEAD-MOUNTED DISPLAY (HMD)

(71) Applicant: QUALCOMM Incorporated, San Diego, CA (US)

(72) Inventors: Simon Peter William Booth, San Diego, CA (US); Kapil Ahuja, Bengaluru (IN); Wesley James Holland, Encinitas, CA (US); Manmohan Manoharan, Bengaluru (IN); Pawan Kumar Baheti, San Diego, CA (US); Animesh Behera, Bengaluru (IN)

(21) Appl. No.: 19/484,714

(22) PCT Filed: Sep. 27, 2023
(86) PCT No.: PCT/US2023/075189

§ 371 Date: Nov. 14, 2025

(30) Foreign Application Priority Data
May 23, 2023 (IN) 202341035791

(51) Int. Cl. G06F 12/0871; G06F 12/0875; G06F 12/0886

(52) U.S. Cl. CPC G06F 12/0871; G06F 12/0875; G06F 12/0886

(57) ABSTRACT

A processor-based system for dynamic allocation of a last level cache to a feature in a head mounted display (HMD) is disclosed. The processor-based system includes a last level cache (LLC) and a processing unit(s) (PU). The PUs utilize the LLC to store interim data to perform their operations in support of a feature running on a HMD. The processing units monitor the available capacity of the LLC and consumption of the LLC by a set of features relative to a set of LLC threshold levels allocated to the set of features. The processing unit is further configured to determine whether the available capacity of the LLC reaches a desired level, and, in response to determining that the available capacity achieves the desired level, increases the allocation of the LLC for a feature in the set of features by a portion of the available capacity.

### PRIORITY APPLICATION

The present application claims priority to Indian Provisional Patent Application Serial No. 202341035791, filed May 23, 2023 and entitled “DYNAMIC ALLOCATION OF A LAST LEVEL CACHE (LLC) TO A FEATURE IN A HEAD-MOUNTED DISPLAY (HMD),” which is incorporated herein by reference in its entirety.

### BACKGROUND

### I. Field of the Disclosure

The technology of the disclosure relates generally to augmented reality technologies deployed in a head-mounted display.

### II. Background

Augmented reality (AR) is a technology that superimposes a computer-generated image on a user's view of the real world, thus providing a composite view. AR headsets are devices that enable users to experience AR. They typically have a display that projects images onto the user's eyes, and they may also have sensors that track the user's head and body movements. There are a number of different technologies that are deployed in AR headsets. Some of the major technologies include head-mounted displays (HMDs), projection systems, spatial tracking, and three-dimensional (3D) graphics and AR applications. HMDs are the most common type of AR headset. They typically have a pair of displays that project images onto the user's eyes. HMDs can be either wired or wireless. Projection systems project images onto a surface in front of the user. This can be done using a variety of different technologies, such as lasers or projectors. Spatial tracking is the ability to track the user's head and body movements. Spatial tracking can be done using a variety of different technologies, such as cameras, sensors, or lasers. Spatial tracking algorithms have tight performance requirements in order to provide a realistic AR experience while not causing a user to become nauseated. 3D graphics are used to create the virtual objects that are displayed in AR on the HMDs. 3D graphics can be created using a variety of different software programs. AR applications are software code whose purpose is to deploy an AR experience to gaming, productivity, and life-assisting tasks. These AR applications include 3D graphics, track the user's movements, and interact with virtual objects.

These technologies run on microprocessors, also known as processing units (PUs), which perform computational tasks in support of the AR applications. One type of conventional microprocessor or PU is a central processing unit (CPU). Another type of microprocessor or PU is a dedicated processing unit known as a graphics processing unit (GPU). A GPU is designed with specialized hardware to accelerate the rendering of graphics and video data for display. A GPU may be implemented as an integrated element of a general-purpose CPU or as a discrete hardware element that is separate from the CPU. A PU(s) executes software instructions that instruct a processor to fetch data from a location in memory and to perform one or more processor operations using the fetched data. The result may then be stored in memory. For example, this memory can be a cache memory local to the PU, a shared local cache among PUs in a PU block, a shared cache among multiple PU blocks, and/or a system memory in a processor-based system. Cache memory, which can also be referred to as just “cache,” is a smaller, faster memory that stores copies of data stored at frequently accessed memory addresses in a main memory or higher-level cache memory to reduce memory access latency. Thus, a cache memory can be used by a PU to reduce memory access times.

When data requested by a memory read request is present in a cache memory (i.e., a cache “hit”), system performance may be improved by retrieving the data from the cache instead of slower access system memory. Conversely, if the requested data is not found in the cache (resulting in a cache “miss”), the requested data then must be read from a higher-level cache memory or a system memory. Frequent occurrences of cache misses result in system performance degradation that could negate the advantage of using the cache in the first place. The cache hit rate of cache memory can generally be improved by increasing the size of the cache memory because a larger cache memory can store more cache lines, thus increasing the likelihood of a cache hit. However, increasing the size of cache memory comes at an increased cost in terms of increased area and power consumption.

Returning to the situation when requested data is read from a higher-level cache memory or a system memory on a cache miss, the requested data is typically stored in cache memory local to a PU for later use. Often writing the requested data to the local cache will cause an existing cache line from the local cache to be evicted. The evicted cache line may need to be written to a higher-level cache memory to be subsequently shared among other PUs. As such, higher-level cache memory is typically larger than lower-level cache memory and may contain many unallocated or invalid cache lines. Writing or allocating the evicted line to a higher-level cache memory can influence the cache hit rate of the higher-level cache memory and the performance of the PUs sharing the higher-level cache memory.

### SUMMARY

Aspects disclosed in the detailed description include a processor-based system for allocation of a last level cache (LLC) to a feature in a head-mounted display (HMD). Related processor-based apparatus and methods are also disclosed. The processor-based system includes an LLC and a processing unit (PU) such as a central processing unit (CPU) and/or a dedicated PU, such as a graphics processing unit (GPU), a video PU (VPU), imaging real-time PU (IRTPU), imaging non-real-time PU (INRTPU), neural engine PU (NEPU), display PU (DPU), and the like. The PUs utilize the LLC to store interim data to perform their operations in support of a feature running on an HMD. Because specifying a fixed size of an LLC during design is a tradeoff between cost and quality level to provide for a set of features that will consume the LLC while running on the HMD, the size of conventional LLCs is generally selected based on a fixed quality level for all the features that run on the system. As a result, when the demand for a subset of the set of features drops during operation, the quality of the remaining set of features is static. In contrast, the processing unit, disclosed in the processor-based system disclosed herein, is also configured to monitor the available capacity of the LLC and monitor consumption of the LLC by a set of features relative to a set of LLC threshold levels allocated to the set of features. The processing unit is further configured to determine whether the available capacity of the LLC reaches a desired level, and, in response to determining that the available capacity achieves the desired level, increases the allocation of the LLC for a feature in the set of features by a portion of the available capacity. In this regard, the initial or static allocation to a set of features running on the processor-based system can be designed for a base level quality and dynamically reallocated during operation to consume the available capacity of the LLC and increase the quality for the feature, such as the image quality when decoding an image or throughput quality for processing an image in a human or computer vision pipeline of processing units.

In this regard, in one aspect, a processor-based system for dynamically allocating a last level cache (LLC) comprises a LLC and a processing unit. The processing unit is configured to monitor an available capacity of the LLC, monitor consumption of the LLC by a set of features relative to a set of LLC threshold levels allocated to the set of features and determine whether the available capacity of the LLC achieves a desired level. The processor-based system is also configured, in response to determining that the available capacity achieves the desired level, to increase an allocation of the LLC for a feature in the set of features by a portion of the available capacity.

In another aspect, a method for dynamically allocating a last level cache (LLC) comprises monitoring an available capacity of an LLC, monitoring consumption of the LLC by a set of features relative to a set of LLC threshold levels allocated to the set of features, and determining whether the available capacity of the LLC achieves a desired level. The method further comprises, in response to determining that the available capacity achieves the desired level, increasing an allocation of the LLC for a feature in the set of features by a portion of the available capacity.

### BRIEF DESCRIPTION OF THE DRAWINGS

FIG. 1 is a block diagram of an exemplary processor-based system to allocate a last level cache (LLC) to a feature in a head-mounted display (HMD);

FIG. 2 is a block diagram of exemplary metadata utilized by the cache allocation and tracking circuit of FIG. 1 which stores the allocation and the consumption of the LLC based on both a feature and processing unit basis in order to track and allocate an LLC to a feature in an HMD;

FIG. 3 is a block diagram of an exemplary flow of information to increase the quality of image decoding between a companion device and an HMD in response to increasing or decreasing the allocation level for an image decoding feature in an LLC at an HMD;

FIG. 4 is a block diagram of an exemplary configuration of a computer vision pipeline whose throughput is increased or decreased based on the dynamic allocation for the computer vision pipeline feature in an LLC at an HMD;

FIG. 5 is a block diagram of an exemplary configuration of a human vision pipeline whose throughput is increased or decreased based on the allocation level for the human vision pipeline feature in an LLC at an HMD;

FIG. 6 is a flowchart illustrating an exemplary process for dynamically allocating an LLC to a feature in an HMD, the LLC deployed in a processor-based system including, but not limited to, processor-based system of FIG. 1; and

FIG. 7 is a block diagram of an exemplary processor-based system that can include the cache allocation and tracking circuit of FIG. 1 for dynamically allocating an LLC to a feature in an HMD.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a processor-based system for allocation of a last level cache (LLC) to a feature in a head-mounted display (HMD). Related processor-based apparatus and methods are also disclosed. The processor-based system includes an LLC and a processing unit (PU) such as a central processing unit (CPU) and/or a dedicated PU, such as a graphics processing unit (GPU), a video PU (VPU), imaging real-time PU (IRTPU), imaging non-real-time PU (INRTPU), neural engine PU (NEPU), display PU (DPU), and the like. The PUs utilize the LLC to store interim data to perform their operations in support of a feature running on an HMD. Because specifying a fixed size of an LLC during design is a tradeoff between cost and quality level to provide for a set of features that will consume the LLC while running on the HMD, the size of conventional LLCs is generally selected based on a fixed quality level for all the features that run on the system. As a result, when the demand for a subset of the set of features drops during operation, the quality of the remaining set of features is static. In contrast, the processing unit, disclosed in the processor-based system disclosed herein, is also configured to monitor the available capacity of the LLC and monitor consumption of the LLC by a set of features relative to a set of LLC threshold levels allocated to the set of features. The processing unit is further configured to determine whether the available capacity of the LLC reaches a desired level, and, in response to determining that the available capacity achieves the desired level, increases the allocation of the LLC for a feature in the set of features by a portion of the available capacity. In this regard, the initial or static allocation to a set of features running on the processor-based system can be designed for a base level quality and dynamically reallocated during operation to consume the available capacity of the LLC and increase the quality for the feature, such as the image quality when decoding an image or throughput quality for processing an image in a human or computer vision pipeline of processing units.

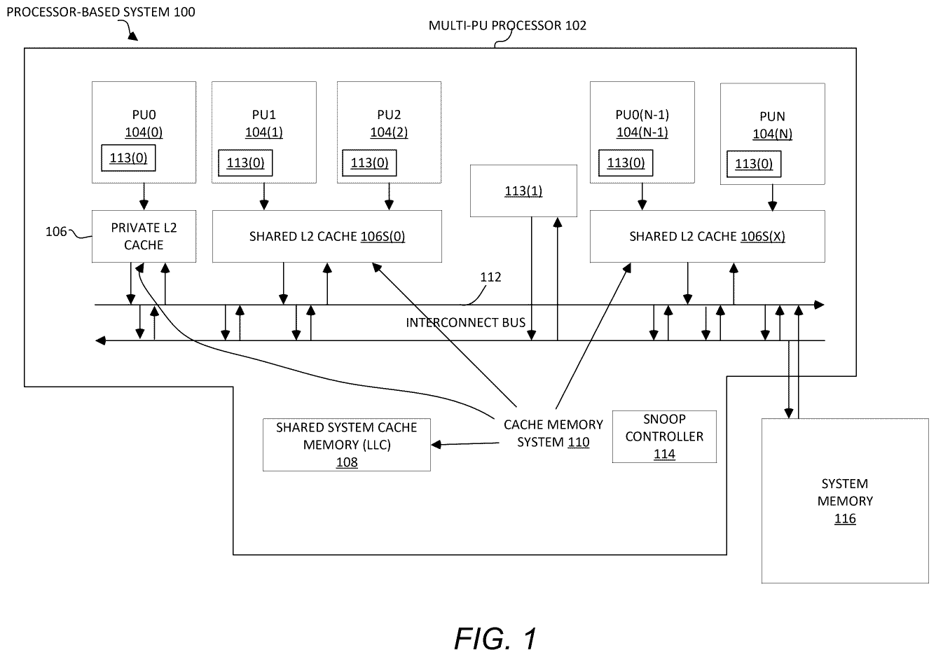

In this regard, FIG. 1 is a block diagram of an exemplary processor-based system 100 to allocate an LLC to a feature in an HMD. Before discussing this aspect, other exemplary aspects of the processor-based system 100 are first described below.

The processor-based system 100 includes a multiple (multi-) processing unit (PU) (multi-PU) processor 102 that includes multiple PUs 104(0)-104(N) and a hierarchical memory system. As part of the hierarchical memory system, for example, PU 104(0) includes a private local cache memory 106, which may be a Level 2 (L2) cache memory. PUs 104(1), 104(2) and PUs 104(N-1), PU 104(N) are configured to interface with respective local shared cache memories 106S(0)-106S(X), which may also be L2 cache memories for example. If a data read request requested by a PU 104(0)-104(N) results in a cache miss to the respective cache memories 106, 106S(0)-106S(X), the read request may be communicated to a next-level cache memory, which in this example is a shared system cache memory 108, also known in this example as LLC 108. For example, the LLC 108 may be a Level 3 (L3) cache memory. The local cache memory 106, the local shared cache memories 106S(0)-106S(X), and the LLC 108 are part of a hierarchical cache memory system 110. An interconnect bus 112, which may be a coherent bus, is provided that allows each of the PUs 104(0)-104(N) to access the local shared cache memories 106S(0)-106S(X) (if shared to the PU 104(0)-104(N)), the LLC 108, and other shared resources coupled to the interconnect bus 112. On a memory request, for example, if there is a cache miss in the L2 cache 106S(0), a snoop controller 114 may be utilized to determine if the memory request should target a another L2 cache before targeting the LLC 108. If a memory request targets the LLC 108 and the memory request misses in the LLC 108, the memory request will target system memory 116. System memory 116 may be a dual data rate (DDR) memory whose access time is slower than the LLC 108.

The processor-based system 100 in FIG. 1 includes a cache allocation and tracking circuit 113 that is configured to allocate or write a cache line to a higher-level cache memory in response to an eviction request of a lower-level-cache line. The cache allocation and tracking circuit 113 may be distributed between a local cache allocation and tracking circuit 113(0), which resides in any or all PUs 104(0)-104(N), and a remote cache allocation and tracking circuit 113(1), which resides in the multi-PU processor 102. The remote cache allocation and tracking circuit 113(1) may alternatively reside in the interconnect bus 112 or any other higher-level cache memory, such as the LLC 108.

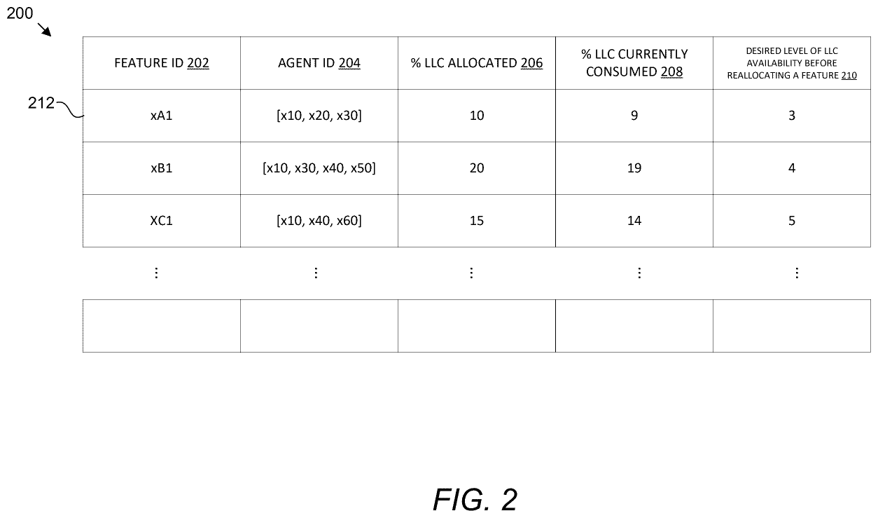

In this example, in response to an eviction request of a lower-level cache line from the local cache memory 106 or local shared cache memories 106S(0)-106S(X), the cache allocation and tracking circuit 113 determines whether storing the lower-level cache line is within the current allocation for a feature to which the cache line is associated. Metadata associated with the cache line includes an agent identifier (ID) id which corresponds to the processing unit that initiated the memory request and a feature ID which indicates a feature in a set of features allocated to utilize the LLC 108. An exemplary feature may include, but is not limited to, decoding an image, computer vision pipeline configuration, and human vision pipeline configuration. If the threshold for the feature ID associated for the cache line has not been met, the cache allocation and tracking circuit 113 will allow the cache line to be written to the LLC 108. If the LLC 108 has available capacity, the cache allocation and tracking circuit 113 will determine whether to deploy that excess capacity to increase or decrease the quality of a feature. Details of the cache allocation and tracking circuit 113 will be discussed further in connection with FIG. 2.

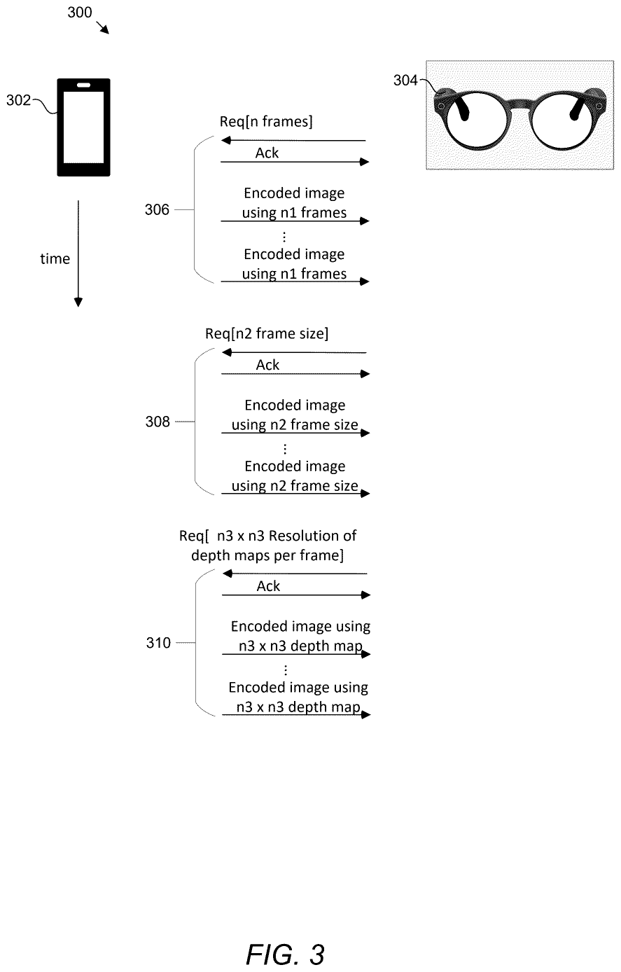

FIG. 2 is a block diagram of exemplary metadata 200 utilized by the cache allocation and tracking circuit 113 of FIG. 1 which stores the allocation and the consumption of the LLC based on both a feature and processing unit basis in order to track and allocate an LLC to a feature in an HMD. The metadata 200 includes a feature ID 202 which corresponds to a feature that runs on the HMD. The feature ID 202 is a unique identifier associated with a feature in an HMD. Exemplary features include decoding an image which includes specifying the number of reference frames used in decoding the image, the resolution of an image frame, and the size of a depth map for an image frame. Other exemplary features may also include a buffer configuration of a computer vision pipeline and a buffer configuration of a human vision pipeline. Those exemplary features will be discussed in more detail in connection with FIGS. 3-5. The metadata 200 also includes an agent ID 204. The agent ID 204 is a unique identifier associated with a PU 104(0)-104(N) in the processor-based system 100. The metadata 200 includes a percentage of the LLC allocated 206 to the feature ID 202, a percentage of the LLC currently consumed 208 by the feature ID 202, and a desired level of LLC availability before reallocating a feature 210.

For example, in row 212, feature ID xA1 is being accomplished by PUs x10, x20, and x30. When a memory request is received by the cache allocation and tracking circuit 113, the cache allocation and tracking circuit 113 will read the feature ID 202 and agent ID 204 carried with the memory request and compare with the metadata 200 to track the percentage of the LLC currently consumed 208 by the feature ID 202. If the memory request is written to the LLC 108, the cache allocation and tracking circuit 113 increases the percentage of the LLC 108 currently consumed 208 for that feature ID 202 accordingly and decreases the overall available capacity of the LLC 108. When a memory request evicts a cache line from the LLC 108, the cache allocation and tracking circuit 113 decreases the percentage of the LLC 108 currently consumed 208 for that feature ID 202 accordingly and increases the overall available capacity of the LLC 108. On a periodic basis, the cache allocation and tracking circuit 113 will review the available capacity of the LLC 108 and determine if the available capacity is greater than the desired level of LLC availability before reallocating a feature 210. If the available capacity, which is the total capacity of the LLC 108 minus a summation of the column 208, is greater than a desired level of LLC availability before reallocating a feature 210, the cache allocation and tracking circuit 113 will dynamically allocate more capacity to the feature ID in the LLC 108. Once more capacity of the LLC 108 is allocated to the feature ID 202, the cache allocation and tracking circuit 113 can signal the PUs associated with the feature ID 202 to increase the quality level of the feature which will be described in more detail in FIGS. 3-5.

Conversely, if the percentage of the LLC currently consumed 208 for a feature ID 202 is less than the percentage of the LLC allocated 206 to the feature ID 202, the cache allocation and tracking circuit 113 can signal the PUs associated with the feature ID 202 to decrease the quality level of the feature. There may be many features in a set of features running on an HMD whose quality can be modified by dynamically allocating the LLC 108 to a respective feature. FIGS. 3-5 are exemplary features in a feature set whose quality level is increased or decreased by dynamically allocating the LLC 108 to a feature ID 202.

FIG. 3 is a block diagram 300 of an exemplary flow of information of three scenarios to increase the quality of image decoding between a companion device 302 and an HMD 304 in response to increasing or decreasing the allocation level for an image decoding feature in an LLC at an HMD. The HMD 304 includes the processor-based system 100 described in FIG. 1. The HMD 304 also includes a computer vision camera for grey scale video capture and a human vision camera for capturing RGB quality video to present to a user. Scenario 306 illustrates the communication flow after the processor-based system 100 determines to dynamically allocate the LLC 108 to increase the quality of image decoding by increasing the number of reference frames used in the decoding process at the HMD 304 and storing the number of reference frames in the LLC 108. In scenario 306, the HMD 304 instructs the companion device 302 to encode images using n1 number of video reference frames after increasing the allocation of the LLC 108 to the feature of decoding an image. A video reference frame is a video frame that was previously rendered and is utilized as a basis for rendering a current frame. The greater number of video reference frames used for encoding increases the quality of the encoded image at the expense of storage for the number of video reference frames. The companion device 302 acknowledges the request and then encodes subsequent images utilizing the n1 number of video reference frames.

Scenario 308 illustrates the communication flow after the processor-based system 100 determines to dynamically allocate the LLC 108 to increase the quality of decoding an image by increasing video frame size (also known as increasing the frame resolution) used in the decoding process at the HMD 304 and storing the increased video frame size in the LLC 108. In scenario 308, the HMD 304 instructs the companion device 302 to encode images using an n2 video frame size after increasing the allocation of the LLC 108 to the feature of decoding an image. The greater size of the video frame used for encoding increases the quality of the encoded image at the expense of storage for storing the increased size of the video frame. The companion device acknowledges the request and then encodes subsequent images utilizing video frames of size n2.

Scenario 310 illustrates the communication flow after the processor-based system 100 determines to dynamically allocate the LLC 108 to increase the quality of decoding an image by modifying the size of a depth map for a video frame used in the decoding process at the HMD 304 and storing the modified sized depth maps in the LLC 108. In scenario 310, the HMD 304 instructs companion device 302 to encode images using an n3×n3 depth map for a video frame after increasing the allocation of the LLC 108 to the feature of decoding an image. The smaller resolution of the depth map used for encoding increases the quality of the encoded image at the expense of storage for storing the increased number of depth maps in the LLC 108. For example, if the initial size of a depth map for a 16×16 block frame is 8×8, there will be four (4) 8×8 depth maps. When the processor-based system 100 determines to dynamically allocate the LLC 108 to increase the quality of the image by utilizing 4×4 depth maps, sixteen (16) 4×4 depth maps will be stored in the LLC 108. The companion device 302 acknowledges the request and then encodes subsequent images utilizing n3×n3 depth maps.

Known encoding techniques including, but not limited to, H.264, H.265 can be used for the encoding and decoding processes in both the companion device 302 and the HMD 304. The same communication flow is used when decreasing the quality of the image in scenarios 306, 308, and 310 simply by changing the values for n1, n2 and n3.

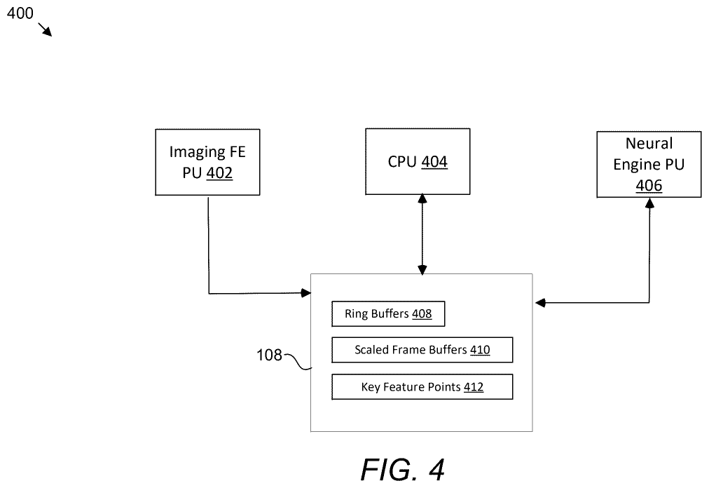

FIG. 4 is a block diagram of an exemplary configuration of a computer vision pipeline 400 whose throughput is increased or decreased based on the dynamic allocation for the computer vision pipeline feature in an LLC 108 at an HMD 304. The computer vision pipeline 400 includes an imaging front end PU 402, a central PU 404, and a neural engine PU 406. The imaging front end PU 402, the central PU 404, and the neural engine PU 406 are PUs in the processor-based system 100 which is deployed in the HMD 304. Based on dynamically allocating the feature of the computer vision pipeline, the LLC 108 is shown to include interim buffers such as allocated ring buffers 408, scaled frame buffers 410, and key feature points 412. The more ring buffers 408, scaled frame buffers 410, and key feature points 412 are stored in the LLC 108, the greater the throughput of the computer vision pipeline 400 for processing an image is improved.

In operation, the imaging front end PU 402 samples grey scale pixel images from a monochromatic sensor. The pixel image is typically a 1024×1024 pixel image. The imaging front end PU 402 stores the image in 1024×1024 ring buffers 408 in the LLC 108. The central PU 404 reads the ring buffers 408 and optionally downscales the image depending on an algorithm in the neural engine PU 406 which would consume the image and stores the downscaled image in the scaled frame buffers 410 in the LLC 108. The neural engine PU 406 can be trained for various computer vision features including, but not limited to, hand tracking, head tracking, and/or generic object tracing. The training of the neural engine PU 406 determines the need and extent of image down scaling by the central PU 404. The neural engine PU 406 reads from the scaled frame buffers 410 and determines key feature points within the image and stores them to the key feature points 412 in the LLC 108. Although the configuration of the computer vision pipeline 400 is shown to include all buffers in the LLC 108, the extent of the distribution for storing the buffers in the system memory 116 and the LLC 108 is determined by the available capacity of LLC and the extent to whether to increase or decrease the throughput quality of the computer vision pipeline feature in accordance with the metadata 200.

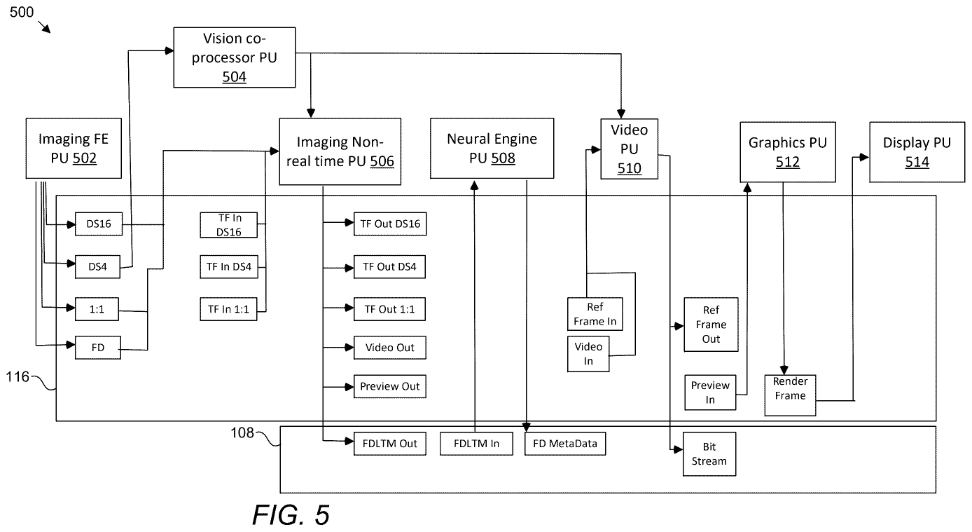

FIG. 5 is a block diagram of an exemplary configuration of a human vision pipeline 500 whose throughput is increased or decreased based on the dynamic allocation level for the human vision pipeline feature in an LLC 108 at an HMD 304. The human vision pipeline 500 is a red, green, blue (RGB) pipeline and includes an imaging front end PU 502, a vision co-processor PU 504, an imaging non-real time PU 506, a neural engine PU 508, a video PU 510, a graphics PU 512 and a display PU 514. The imaging front end PU 502, the vision co-processor PU 504, the imaging non-real time PU 506, the neural engine PU 508, the video PU 510, the graphics PU 512, and the display PU 514 are PUs in the processor-based system 100 which is deployed in the HMD 304. The configuration of the human vision pipeline 500 includes a set of interim buffers stored in the system memory 116 and a set of interim buffers stored in the LLC 108. These interim buffers are created and used for processing captured images. The extent of the distribution for storing the buffers between the system memory 116 and the LLC 108 is determined by the available capacity of the LLC and whether to increase or decrease the throughput quality of the human vision pipeline feature in accordance with the metadata 200. Depending on the use case for which human vision pipeline feature is deployed, different interim buffers may be generated and consumed for that use case.

In operation, imaging FE PU 502 processes 720p video frames at 30 frames per second(fps) and writes interim buffers (DS16, DS4, 1:1, FD) to system memory 116. Vision co-processor PU 504 reads buffer DS4 to perform a motion estimation algorithm and produces motion vectors. These motion vectors are utilized by imaging non-real-time PU 506 and video PU 510 to reduce noise from the captured video frames. TF In DS16, TF In DS4, and TF in 1:1 are interim reference buffers that were generated while processing the previous captured frame(s). Imaging Non-real time PU 506 will utilize the reference interim buffers along with the output of the Vision co-processor PU 504 to generate interim buffers TF Out DS16, TF Out DS4, TF Out 1:1, Video Out, Preview Out, and FDLTM Out. FDLTM Out is stored in the LLC 108 along with FDLTM In and FD Metadata to increase a quality level such as increased throughput of the human vision pipeline. Neural Engine PU 508 reads the FLTM In buffer and generates face detection (FD) metadata. The video PU 510 reads reference frame in buffer(Ref Frame In) and Video In buffers along with the motion vectors generated by vision co-processor PU 504 to encode the video image into a standard encoding image such as H.264 or H.265. Graphics PU 512 reads the Preview In buffer and renders the video frame. Display PU 514 reads the rendered frame and displays the video frame to a display.

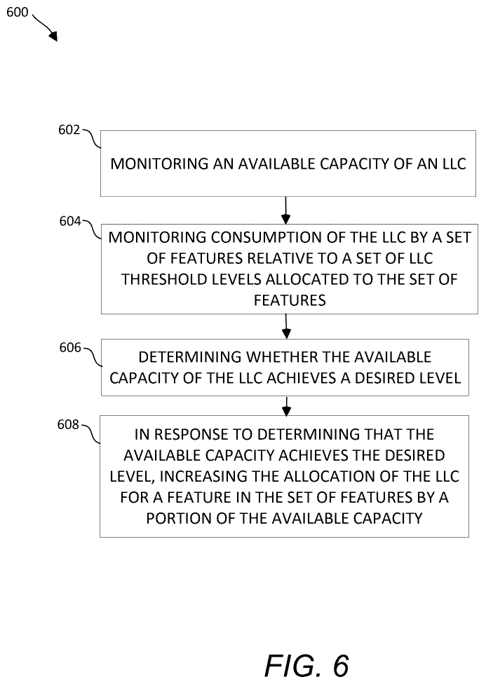

FIG. 6 is a flowchart illustrating an exemplary process 600 for dynamically allocating an LLC to a feature in an HMD, the LLC deployed in a processor-based system including, but not limited to, the processor-based system 100 of FIG. 1. In this regard, a first exemplary step in the process 600 of FIG. 6 can include monitoring an available capacity of an LLC (block 602 in FIG. 6). A next step in the process 600 can include monitoring consumption of the LLC by a set of features relative to a set of LLC threshold levels allocated to the set of features (block 604). A next step in the process 600 can include determining whether the available capacity of the LLC achieves a desired level (block 606). A next step in the process 600 can include, in response to determining that the available capacity achieves the desired level, increasing the allocation of the LLC for a feature in the set of features by a portion of the available capacity.

Electronic devices that include a processor-based system that includes a cache allocation and tracking circuit as shown in FIGS. 1-2 to dynamically allocate a feature in an HMD to utilize available memory in an LLC to improve the quality of the features as described in FIGS. 3-5 and according to, but not limited to, the exemplary processes 600 in FIG. 6, and according to any aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, and an avionics system.

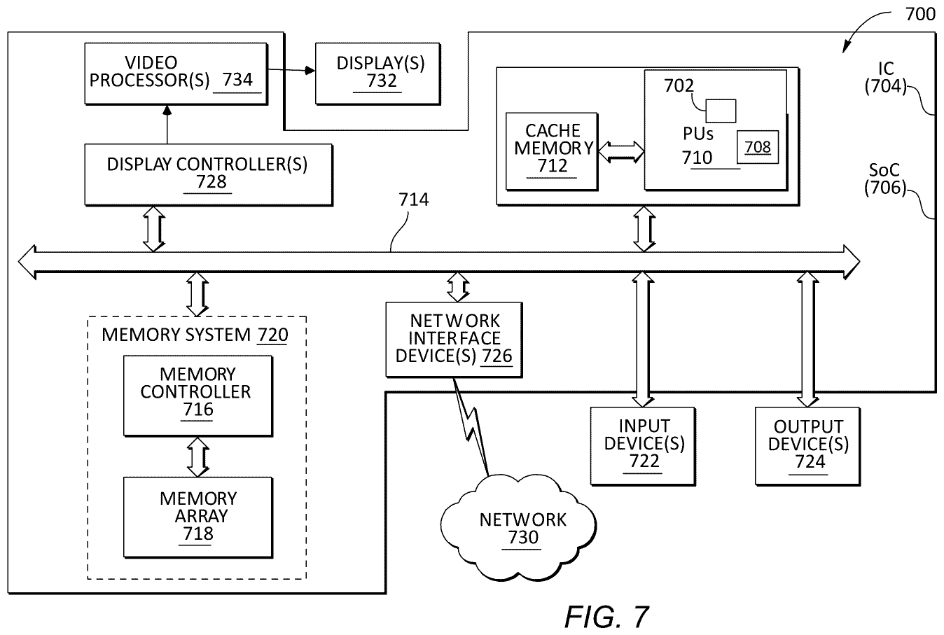

In this regard, FIG. 7 is a block diagram of an exemplary processor-based system 700 that can include the processor-based system 100 and a cache allocation and tracking circuit 113 of FIG. 1 for dynamically allocating an LLC to a feature in an HMD, and according to, but not limited to, the process in FIG. 6. In this example, the processor-based system 700 may be formed as an integrated circuit (IC) 704 and include a cache allocation and tracking circuit 702, such as the cache allocation and tracking circuit 113 described in FIGS. 1-2, and deployed as a system-on-a-chip (SoC) 706. The processor-based system 700 includes a central processing unit (CPU) 708 as one of the one or more processing units 710, which may also be referred to as processor cores. The CPU 708 may have cache memory 712 coupled to the CPU 708 for rapid access to temporarily stored data. The CPU 708 is coupled to a system bus 714 and can intercouple master and slave devices included in the processor-based system 700. As is well known, the CPU 708 communicates with these other devices by exchanging address, control, and data information over the system bus 714. For example, the CPU 708 can communicate bus transaction requests to a memory controller 716, as an example of a slave device. Although not illustrated in FIG. 7, multiple system buses 714 could be provided, wherein each system bus 714 constitutes a different fabric.

Other master and slave devices can be connected to the system bus 714. As illustrated in FIG. 7, these devices can include a memory system 720 that includes the memory controller 716 and a memory array(s) 718, one or more input devices 722, one or more output devices 724, one or more network interface devices 726, and one or more display controllers 728, as examples. Each of the memory system(s) 720, the one or more input devices 722, the one or more output devices 724, the one or more network interface devices 726, and the one or more display controllers 728 can be provided in the same or different electronic devices. The input device(s) 722 can include any type of input device, including, but not limited to, input keys, switches, voice processors, etc. The output device(s) 724 can include any type of output device, including, but not limited to, audio, video, other visual indicators, etc. The network interface device(s) 726 can be any device configured to allow an exchange of data to and from a network 730. The network 730 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 726 can be configured to support any type of communications protocol desired.

The CPU 708 may also be configured to access the display controller(s) 728 over the system bus 714 to control information sent to one or more displays 732. The display controller(s) 728 sends information to the display(s) 732 to be displayed via one or more video processor(s) 734, which process the information to be displayed into a format suitable for the display(s) 732. The display controller(s) 728 and video processor(s) 734 can be included as ICs in the same or different electronic devices and in the same or different electronic device containing the CPU 708, for example. The display(s) 732 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor-based system for dynamically allocating a last level cache (LLC), comprising:
   a LLC; and
   a processing unit configured to:
      monitor an available capacity of the LLC;
      monitor consumption of the LLC by a set of features relative to a set of LLC threshold levels allocated to the set of features;
      determine whether the available capacity of the LLC achieves a desired level; and
      in response to determining that the available capacity achieves the desired level, increase an allocation of the LLC for a feature in the set of features by a portion of the available capacity.
2. The processor-based system of clause 1, wherein the feature is decoding an image, the processing unit being configured to:
   increase a number of reference frames stored in the LLC; and
   decode the image utilizing the number of reference frames.
3. The processor-based system of clause 2, wherein the processing unit is further configured to:
   communicate to a companion device the number of reference frames used for decoding the image.
4. The processor-based system of clause 2 or 3, wherein the processing unit is further configured to:
   determine whether the available capacity of the LLC is less than the desired level; and
   in response to the available capacity of the LLC being less than the desired level:
      decrease the allocation of the LLC for decoding the image; and
      decrease the number of reference frames stored in the LLC.
5. The processor-based system of any of clauses 1-4, wherein the feature is decoding an image, the processing unit being configured to:
   increase a resolution of a video frame stored in the LLC; and
   decode the image utilizing the resolution of the video frame.
6. The processor-based system of clause 5, wherein the processing unit is further configured to:
   determine whether the available capacity of the LLC is less than the desired level; and
   in response to the available capacity of the LLC being less than the desired level:
      decrease the allocation of the LLC for decoding the image; and
      decrease the resolution of the video frame stored in the LLC.
7. The processor-based system of any of clauses 1-6, wherein the feature is decoding an image, the processing unit being configured to:
   increase a resolution of a depth map stored in the LLC; and
   decode the image utilizing the resolution of the depth map.
8. The processor-based system of clause 7, wherein the processing unit is further configured to:
   determine whether the available capacity of the LLC is less than the desired level; and
   in response to the available capacity of the LLC being less than the desired level:
      decrease the allocation of the LLC for decoding the image; and
      decrease the resolution of the depth map stored in the LLC.
9. The processor-based system of clause 1, wherein the feature is computer vision processing of an image, the processor-based system further comprising:
   a plurality of processing units including the processing unit configured to form a computer vision pipeline, wherein a quality level of the feature is lowering latency in the computer vision pipeline;
   wherein the processing unit is configured to store one or more interim buffers in the LLC when processing the image.
10. The processor-based system of clause 9, wherein the processor-based system further comprises:
   a system memory,
   wherein the processing unit is further configured to:
      determine whether the available capacity of the LLC is less than the desired level; and
      in response to the available capacity of the LLC being less than the desired level, the processing unit is configured to store the one or more interim buffers in the system memory when processing the image.
11. The processor-based system of clause 1, wherein the feature is human vision processing of an image, the processor-based system further comprising:
   a plurality of processing units including the processing unit configured to form a human vision pipeline, wherein a quality level of the feature is lowering latency in the human vision pipeline;
   wherein the processing unit is configured to store one or more interim buffers in the LLC when processing the image.
12. The processor-based system of clause 11, wherein the processor-based system further comprises:
   a system memory,
   wherein the processing unit is further configured to:
      determine whether the available capacity of the LLC is less than the desired level; and
      in response to the available capacity of the LLC being less than the desired level, the processing unit is configured to store at least one of the one or more interim buffers in the system memory when processing the image.
13. The processor-based system of clause 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; and an avionics system.
14. A method for dynamically allocating a last level cache (LLC), comprising:
   monitoring an available capacity of an LLC;
   monitoring consumption of the LLC by a set of features relative to a set of LLC threshold levels allocated to the set of features;
   determining whether the available capacity of the LLC achieves a desired level; and
   in response to determining that the available capacity achieves the desired level, increasing an allocation of the LLC for a feature in the set of features by a portion of the available capacity.
15. The method of clause 14, wherein the feature is decoding an image, the method further comprising:
   increasing a number of reference frames stored in the LLC; and
   decoding the image utilizing the number of reference frames.
16. The method of clause 15, further comprising:
   communicating to a companion device the number of reference frames used for decoding the image.
17. The method of clause 15 or 16, further comprising:
   determining whether the available capacity of the LLC is less than the desired level; and
   in response to the available capacity of the LLC being less than the desired level:
      decreasing the allocation of the LLC for decoding the image; and
      decreasing the number of reference frames stored in the LLC.
18. The method of any of clauses 14-17, wherein the feature is decoding an image, the method further comprising:
   increasing a resolution of a video frame stored in the LLC; and
   decoding the image utilizing the resolution of the video frame.
19. The method of clause 18, further comprising:
   determining whether the available capacity of the LLC is less than the desired level; and
   in response to the available capacity of the LLC being less than the desired level:
      decrease the allocation of the LLC for decoding the image; and
      decrease the resolution of the video frame stored in the LLC.
20. The method of any of clauses 14-19, wherein the feature is decoding an image, the method further comprising:
   increasing a resolution of a depth map stored in the LLC; and
   decoding the image utilizing the resolution of the depth map.
21. The method of clause 20, further comprising:
   determining whether the available capacity of the LLC is less than the desired level; and
   in response to the available capacity of the LLC being less than the desired level:
      decreasing the allocation of the LLC for decoding the image; and
      decreasing the resolution of the depth map stored in the LLC.
22. The method of clause 14, wherein the feature is computer vision processing of an image, the method further comprising:
   a plurality of processing units including the processing unit configured to form a computer vision pipeline, wherein a quality level of the feature is lowering latency in the computer vision pipeline;
      wherein the processing unit is configured to store one or more interim buffers in the LLC when processing the image.
23. The method of clause 22, wherein the method further comprises:
   a system memory,
   wherein the processing unit is further configured to:
      determine whether the available capacity of the LLC is less than the desired level; and
      in response to the available capacity of the LLC being less than the desired level, the processing unit is configured to store the one or more interim buffers in the system memory when processing the image.
24. The method of clause 14, wherein the feature is human vision processing of an image, the method further comprising:
   storing one or more interim buffers in the LLC when processing the image.
25. The method of clause 24, wherein the method further comprises:
   determining whether the available capacity of the LLC is less than the desired level; and
   in response to the available capacity of the LLC being less than the desired level, storing at least one of the one or more interim buffers in the system memory when processing the image.

1. A processor-based system for dynamically allocating a last level cache (LLC), comprising:
a LLC; and
a processing unit configured to:
monitor an available capacity of the LLC;
monitor consumption of the LLC by a set of features relative to a set of LLC threshold levels allocated to the set of features;
determine whether the available capacity of the LLC achieves a desired level; and
in response to determining that the available capacity achieves the desired level, increase an allocation of the LLC for a feature in the set of features by a portion of the available capacity.

2. The processor-based system of claim 1, wherein the feature is decoding an image, the processing unit being configured to:
increase a number of reference frames stored in the LLC; and
decode the image utilizing the number of reference frames.

3. The processor-based system of claim 2, wherein the processing unit is further configured to:
communicate to a companion device the number of reference frames used for decoding the image.

4. The processor-based system of claim 3, wherein the processing unit is further configured to:
determine whether the available capacity of the LLC is less than the desired level; and
in response to the available capacity of the LLC being less than the desired level:
decrease the allocation of the LLC for decoding the image; and
decrease the number of reference frames stored in the LLC.

5. The processor-based system of claim 1, wherein the feature is decoding an image, the processing unit being configured to:
increase a resolution of a video frame stored in the LLC; and
decode the image utilizing the resolution of the video frame.

6. The processor-based system of claim 5, wherein the processing unit is further configured to:
determine whether the available capacity of the LLC is less than the desired level; and
in response to the available capacity of the LLC being less than the desired level:
decrease the allocation of the LLC for decoding the image; and
decrease the resolution of the video frame stored in the LLC.

7. The processor-based system of claim 1, wherein the feature is decoding an image, the processing unit being configured to:
increase a resolution of a depth map stored in the LLC; and
decode the image utilizing the resolution of the depth map.

8. The processor-based system of claim 7, wherein the processing unit is further configured to:
determine whether the available capacity of the LLC is less than the desired level; and
in response to the available capacity of the LLC being less than the desired level:
decrease the allocation of the LLC for decoding the image; and
decrease the resolution of the depth map stored in the LLC.

9. The processor-based system of claim 1, wherein the feature is computer vision processing of an image, the processor-based system further comprising:
a plurality of processing units including the processing unit configured to form a computer vision pipeline, wherein a quality level of the feature is lowering latency in the computer vision pipeline;
wherein the processing unit is configured to store one or more interim buffers in the LLC when processing the image.

10. The processor-based system of claim 9, wherein the processor-based system further comprises:
a system memory,
wherein the processing unit is further configured to:
determine whether the available capacity of the LLC is less than the desired level; and
in response to the available capacity of the LLC being less than the desired level, the processing unit is configured to store the one or more interim buffers in the system memory when processing the image.

11. The processor-based system of claim 1, wherein the feature is human vision processing of an image, the processor-based system further comprising:
a plurality of processing units including the processing unit configured to form a human vision pipeline, wherein a quality level of the feature is lowering latency in the human vision pipeline;
wherein the processing unit is configured to store one or more interim buffers in the LLC when processing the image.

12. The processor-based system of claim 11, wherein the processor-based system further comprises:
a system memory,
wherein the processing unit is further configured to:
determine whether the available capacity of the LLC is less than the desired level; and
in response to the available capacity of the LLC being less than the desired level, the processing unit is configured to store at least one of the one or more interim buffers in the system memory when processing the image.

13. (canceled)

14. A method for dynamically allocating a last level cache (LLC), comprising:
monitoring an available capacity of an LLC;
monitoring consumption of the LLC by a set of features relative to a set of LLC threshold levels allocated to the set of features;
determining whether the available capacity of the LLC achieves a desired level; and
in response to determining that the available capacity achieves the desired level, increasing an allocation of the LLC for a feature in the set of features by a portion of the available capacity.

15. The method of claim 14, wherein the feature is decoding an image, the method further comprising:
increasing a number of reference frames stored in the LLC; and
decoding the image utilizing the number of reference frames.

16. The method of claim 15, further comprising:
communicating to a companion device the number of reference frames used for decoding the image.

17. The method of claim 16, further comprising:
determining whether the available capacity of the LLC is less than the desired level; and
in response to the available capacity of the LLC being less than the desired level:
decreasing the allocation of the LLC for decoding the image; and
decreasing the number of reference frames stored in the LLC.

18. The method of claim 14, wherein the feature is decoding an image, the method further comprising:
increasing a resolution of a video frame stored in the LLC; and
decoding the image utilizing the resolution of the video frame.

19. The method of claim 18, further comprising:
determining whether the available capacity of the LLC is less than the desired level; and
in response to the available capacity of the LLC being less than the desired level:
decrease the allocation of the LLC for decoding the image; and
decrease the resolution of the video frame stored in the LLC.

20. The method of claim 14, wherein the feature is decoding an image, the method further comprising:
increasing a resolution of a depth map stored in the LLC; and
decoding the image utilizing the resolution of the depth map.

21. The method of claim 20, further comprising:
determining whether the available capacity of the LLC is less than the desired level; and
in response to the available capacity of the LLC being less than the desired level:
decreasing the allocation of the LLC for decoding the image; and
decreasing the resolution of the depth map stored in the LLC.

22-25. (canceled)
